(19) United States
(12) Patent Application Publication
(10) Pub. No.: US 2023/0267548 A1
(43) Pub. Date: Aug. 24, 2023

(54) SYSTEMS AND METHODS FOR COMPLYING WITH LISTS OF EXCLUDED INDIVIDUALS AND ENTITIES

(71) Applicant: Change Healthcare Holdings, LLC, Nashville, TN (US)

(72) Inventor: John Kristofer Selser, Antioch, TN (US)

(21) Appl. No.: 17/679,320

(22) Filed: Feb. 24, 2022

(51) Int. Cl. G06Q 40/08

(52) U.S. Cl. CPC G06Q 40/08

(57) ABSTRACT

In an embodiment, systems and methods for ensuring compliance with lists of excluded providers are provided. A published list of excluded providers is monitored. When a provider is added to the published list, an entry in a local excluded provider list is created along with a date that indicates when the provider was added. When a provider is removed from the published list, a date that indicates when the provider was removed is added to the entry for the provider in the local excluded provider list. When a claim having a service date is received, the local excluded list and the dates are used to determine if the claim is associated with any provider that was on the published list as of the service date. If the claim is determined to be associated with a provider on the list, the claim is rejected.

### BACKGROUND

The Office of the Inspector General of the United States government maintains a list of entities that are excluded from participating in the health care industry called the “List of Excluded Individuals/Entities” (“LEIE”). Any entities (e.g., medical providers) that appear on the list are excluded from participation in Medicare, Medicaid, and any other Federal Healthcare program.

Accordingly, it is important that healthcare providers and healthcare payers determine excluded entities before performing healthcare services or agreeing to pay for such services. However, there are difficulties in making such determinations. First, the LEIE is updated continuously with entities continuously being added and removed from the LEIE, making keeping up with the most current version of the LEIE difficult. Second, sometimes a claim may be payable even when an associated payor is on the LEIE. Claims are generally associated with a service date that indicates when an associated medical service was performed. A claim associated with a provider that is on the LEIE is payable so long as the entity was not on the LEIE as of the service date. However, the LEIE does not indicate when an entity was placed on the LEIE (or was removed from the LEIE) making such determinations difficult, SUMMARY

In an embodiment, systems, methods, and computer-readable mediums for ensuring compliance with lists of excluded providers such as the List of Excluded Individuals/Entities (“LEIE”) are described. In one embodiment, a published official list of excluded providers is monitored. When a provider is added to the official published list, an entry in a local excluded provider list is created along with a date that indicates when the provider was added. When a provider is removed from the published official list, a date that indicates when the provider was removed is added to the entry for the provider in the local excluded provider list. When a claim is received, the local excluded list is searched for each provider that is associated with the claim. For any providers that match an entry in the local excluded list, the dates associated with each entry in the local excluded list are used to determine if the providers were on the official published excluded provider list at the service date associated with the claim. If any of the providers are determined to have been on the official published list at the service date, the claim is rejected and the organization that provided the claim is notified.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated herein and form part of the specification, illustrate an excluded provider monitoring system and method. Together with the description, the figures further serve to explain the principles of the application catalog system and method described herein and thereby enable a person skilled in the pertinent art to make and use the excluded provider monitoring system and method.

FIG. 1 is an example cloud computing environment for ensuring compliance with excluded provider lists;

FIG. 2 is an illustration of an example method for determining if a claim is compliant with an official list of excluded providers;

FIG. 3 is an illustration of an example method for determining if a claim is compliant with an official list of excluded providers; and

FIG. 4 shows an exemplary computing environment in which example embodiments and aspects may be implemented.

### DETAILED DESCRIPTION

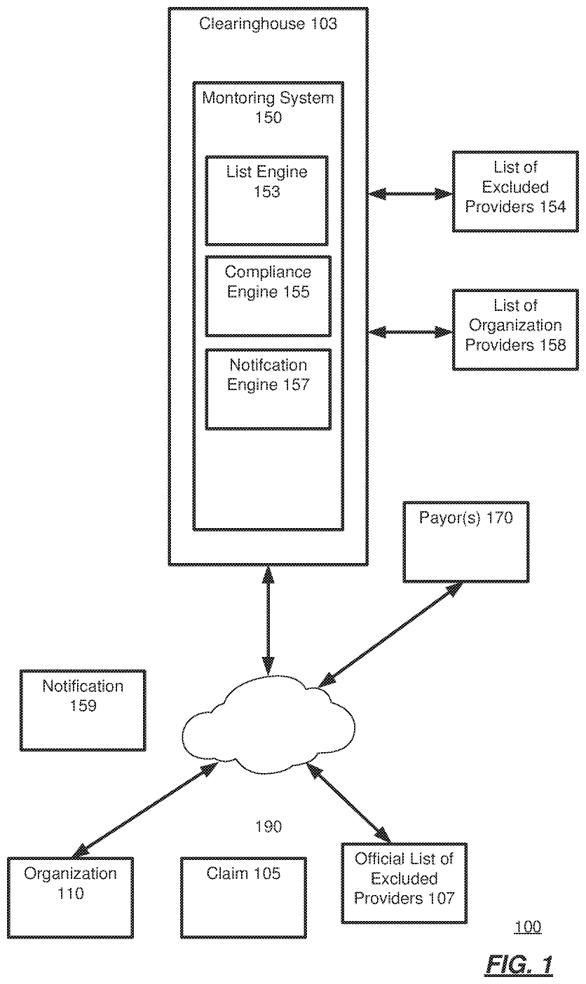

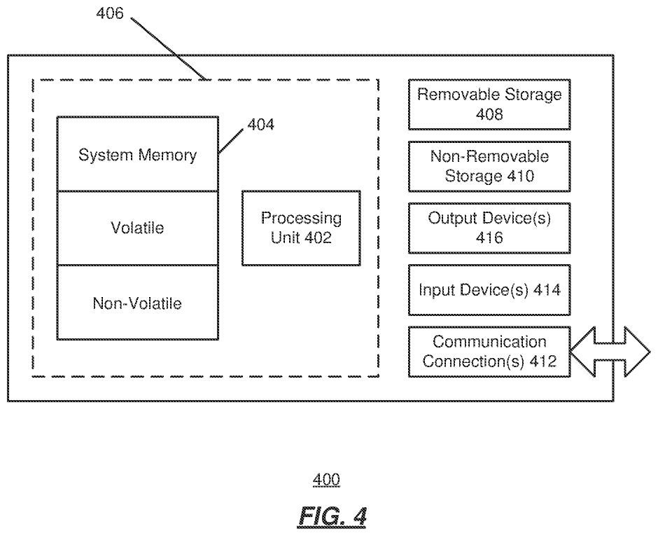

FIG. 1 is an example cloud computing environment 100 for ensuring compliance with excluded provider lists. As shown, the environment 100 includes a clearinghouse 103 that interacts with one or more organizations 110 and payors 170 through a network 190. The network 190 may include a combination of public and private networks. Each of the clearinghouse 103, organizations 110, and payors 170 may be implemented using one or more general purpose computing devices such as the computing device 400 illustrated with respect to FIG. 4.

The clearinghouse 103 may receive claims 105 from a variety of organizations 110 through the network 190. The claims 105 may be medical claims and may be requests for reimbursement for medical services (e.g., medical exams, surgeries, tests, and imaging) and medications. The organizations 110 may include any providers of medical services or medications such as doctors, hospitals, clinics, and pharmacies, for example.

Each claim 105 may be associated with a service date that indicates when the medical services associated with the claim 105 were provided. In addition, each claim may be associated with a plurality of providers that were involved with the medical services associated with the claim 105. The providers may include referring providers, rendering providers, and billing providers, for example.

Because of the complexities associated with submitting medical claims 105, rather than submitting the claims 105 directly to an associated payor 170, the organizations 110 may provide the claims 105 to the clearinghouse 103. The clearinghouse 103 may validate the received claims 105, may make clinical edits to the claims 105 (e.g., adding non-medical information such as statement from dates), and may provide the claims 105 to the payor 170 through the network 190. The clearinghouse 103 may further provide the organizations 110 and payors 170 an interface through which they can view their outstanding or completed claims 105. The payors 170 may include any payor of a medical claim such as an insurance company or government healthcare payor, for example.

Government healthcare payors 170, such as Medicaid and Medicare, may have additional requirements as to the claims 105 that they receive. One such requirement is compliance with one or more lists of excluded providers (i.e., the official list of Excluded providers 107). In general, the official list of excluded providers 107 identifies providers that are precluded from participating in government healthcare services due to certain criminal offences such as Medicare or Medicaid fraud. In addition, any organization 110 that employs or uses the services of a provider on the official list 107 may be subject to civil penalties. The identified providers may include individual providers such as doctors and nurses, organizations such as clinics or hospitals, and indirect providers such as vendors.

The official list of excluded providers 107 may be published by one or more government healthcare payors 170. An example list is the List of Excluded Individuals/Entities (“LEIE”). Other lists may be used. The official list of excluded providers 107 may be updated on a regular basis. In each update, one or more providers may be added or removed from the official list of excluded providers 107.

As may be appreciated, a provider is only prevented from participating in government healthcare services while they are listed on the official list of excluded providers 107. Accordingly, a claim 105 associated with a provider on the list 107 that has a service date that is before the payor was placed on the list 107 is valid and payable. Similarly, a claim 105 associated with the provider who is removed from the list 107 with a service date that is during the time when the provider was on the list 107 is not valid and payable even though the provider is not currently on the list. However, the official list of excluded providers 107 may not indicate when providers were placed on the list 107, nor include information about providers that were removed from the list 107.

Accordingly, to allow a clearinghouse 103 to help organizations 110 comply with the official list of excluded providers 107, the clearinghouse 103 may further include a monitoring system 150. The monitoring system 150 may be a smart system that tracks and records when providers are added to, and removed from, the official list of excluded providers 107. When a claim 105 is received from an organization 110, the monitoring system 150 checks if any of the associated providers were on the official list of excluded providers 107 on the service date associated with the claim 105. If so, the clearinghouse 103 notifies the organization 110 that the claim 105 may not comply with the official list of excluded providers 107.

The monitoring system 150 described herein provides many advantages. First, by ensuring that the claims 105 are not associated with any providers on the official list of excluded providers 107 before the claims 105 are submitted to government healthcare payors 170, the organizations 110 can avoid risk of non-payment and/or penalties associated with non-compliance with the official list of excluded providers 107. Second, because the system 150 tracks the dates of when providers are added and removed from the list 107, the organizations 110 can be assured that claims 105 with service dates that fall outside of those dates are timely filed with the government healthcare payors 170 even where some of the providers associated with the claim 105 were/are on the list 107 at one point in time.

As shown, the monitoring system 150 may include several components including, but not limited to, a list engine 153, a compliance engine 155, and a notification engine 157. More or fewer components may be supported. The various components of the monitoring system 150 may be implemented together or separately using one or more general purpose computing devices such as the computing device 400 illustrated with respect to FIG. 4.

The list engine 153 may monitor the official list of excluded providers 107 and may track when providers are added and removed from the list 107. Depending on the embodiment, the list engine 153 may monitor a webpage or other location where the official list of excluded providers 107 is periodically published. The list engine 153 may then compare a currently published list of excluded providers 107 with a previously published list to determine any changes. Other methods may be used.

In some embodiments, the list engine 153 may maintain a custom list of excluded providers 154 that is based on the official list of excluded providers 107. The custom list of excluded providers 154 may include an entry for each provider that was added to the official list of excluded providers 107 along with a date when the provider was first added to the list 107. Each entry may include the name of the provider and a unique identifier of the provider such as a National Provider Identifier (“NPI”). In addition, for providers that are added to the official list of excluded providers 107 and are later removed, the custom list of excluded providers 154 may include the date when the provider was removed from the list 107, along with the date that the provider was added.

The compliance engine 155 may receive a claim 105 and may ensure that the claim 105 complies with the official list of excluded providers 107. As described above, a claim 105 may be associated with one or more providers and a service date. The service date may be the date that the medical service associated with the claim 105 was rendered to a patient by one of the one or more providers associated with the claim 105. A claim 105 is not compliant with the official list of excluded providers 107 if it is associated with a provider who appeared on the official list of excluded providers 107 on the service date associated with the claim 105. However, as described above, the official list of excluded providers 107 does not include a date when each provider was added, and there is no indication made in the list 107 of providers who were removed from previous versions of the list 107.

Accordingly, to ensure compliance with the official list of excluded providers 107, and past versions of the list 107, when a claim 105 is received from an organization 110 for submission to a government payor 170, the compliance engine 155 may search the custom list of excluded providers 154 for each provider that is associated with the received claim 105. Any method for searching a list using keywords may be used. Depending on the embodiments, the compliance engine 155 may search the custom list of excluded providers 154 using the NPI of the providers, names of the providers, or other identifying information associated with the providers. In addition, to avoid false positives, address or other information associated with each provider may be used to verify providers on the custom list of excluded providers 154.

For each provider that matches an entry in the list 154, the compliance engine 155 may use the service date associated with the claim 105 to determine if the provider was an excluded provider as of the service date. In some embodiments, the provider is an excluded provider if the service date of the claim 105 is within the date range associated with the provider in the list 154. As described above, each entry in the list 154 may include a first date when the provider was added to the list and, if applicable, a second date that the provider was removed from the list. The compliance engine 155 may determine that the provider associated with claim 105 is not compliant with the official list 107 at the time of the service date of the claim 105 if the service date is within the first and second date. Where there is no removal date, the compliance engine 155 may use the present date as the second date. Other methods may be used.

The notification engine 157 may generate one or more notifications 159 based on whether or not a claim 105 complies with the official list of service providers 107. When the compliance engine 155 determines that a claim 105 is non-compliant due to a provider being on the list 107 as of the service date, the notification engine 157 may generate a notification 159 that lists each provider that was on the list 107 and explains that the claim 105 cannot be submitted to a government payor 170 due to the non-compliance. In the event that the claim 105 is resubmitted by the organization 110, the compliance engine 155 may cause the claim 105 to be submitted to the government payor 170. As may be appreciated, there are exceptions to the list 107 that may be known to the organization 110.

In some embodiments, the compliance engine 155 may determine that a claim 105 has been resubmitted by the organization 110 by maintaining a list of all claims 105 that were previously found to be non-compliant and rejected. The entry in the list for a claim 105 may include some or all of the elements or fields of the claim 105 such as patient, service (e.g., treatment or diagnostic), payer, submitter, dates of service, claim reference numbers, etc. Other fields may be included. Later, when a claim 105 is received, it is checked against the list of claims. If the claim 105 is on the list, indicating the claim 105 is a resubmission, the compliance engine 155 may allow the claim 105 to be submitted to the government payor 170 even if the claim 105 is non-compliant. Alternatively, the compliance engine 155 may use existing duplicate claim detection functionality that is integrated into the clearinghouse 103 to determine that a claim 105 has been resubmitted.

In addition, when the compliance engine 155 determines that no providers associated with the claim 105 were on the list 107 as of the service date of the claim 105, the notification engine 157 may send a notification 159 to the organization 110 that indicates the compliance and that the claim 105 can be submitted to the government payor 170 identified in the claim 105. Alternatively or additionally, the compliance engine 155 may simply submit the claim 105 to the government payor 170 for payment.

In some embodiments, when the compliance engine 155 determines that a provider associated with the claim 105 was on the list 107, but not at the service date associated with the claim 105, the notification engine 157 may also send a notification 159 to the organization 110. The notification 159 may indicate that the claim 105 does comply with the list 107 and can be sent to the government payor 170 but may also indicate the providers that were on the list 107 and the relevant dates. As may be appreciated, an organization 110 may desire to be aware of its providers who were/are on the official list of excluded providers 107, even after they have been removed.

As another service, the compliance engine 155 may keep track of the providers that were associated with the claims 105 submitted by each organization 110. The providers may be stored for each organization 110 as the list of organization providers 158. The compliance engine 155 may periodically search the custom list of excluded providers 154 to determine if any of the providers on the list of organization providers 158 have been added to the list 154, and therefore no longer comply with the official list of excluded providers 107. If a provider is determined to be added to the list 154, the notification engine 157 may send a notification 159 to the associated organization 110 that identifies the provider and includes the date when the provider became non-compliant. As may be appreciated, an organization 110 may desire to act with respect to the provider so that no claims 105 are generated by the provider while the provider is on the official list of excluded providers 107. Once the compliance engine 155 detects that the provider has been removed from the list 154, the notification engine 157 may generate and send a follow up email or notification that indicates the date when the provider was removed.

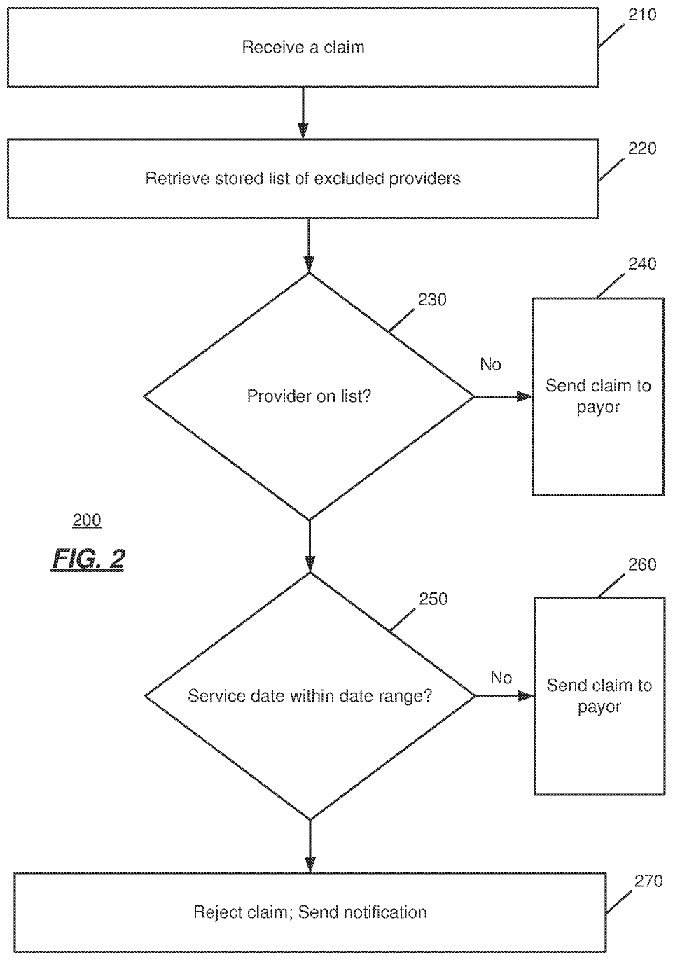

FIG. 2 is an illustration of an example method for determining if a claim is compliant with an official list of excluded providers. The method 200 may be implemented by the monitoring system 150.

At 210, a claim is received. The claim 105 may be received by the clearinghouse 103 from an organization 110 such as a hospital or medical office. The claim 105 may be a medical claim 105 and may be associated with a government payor 170 such as Medicare or Medicaid. The claim 105 may further include a service date that indicates the date or dates that the medical services were provided. The claim 105 may further identify one or more providers. The providers may be medical providers and may be providers who directly, or indirectly, provided the medical services associated with the claim 105. The providers may include referring providers, rendering providers, and billing providers, for example.

At 220, a stored list of excluded providers is retrieved. The stored list may be retrieved by the compliance engine 155. The stored list may be the custom list of excluded providers 154 that is based on an official list of excluded providers 107. The official list 107 may be published by a government entity or government payor 170. An example official list 107 is the List of Excluded Entities/Individuals published by the Office of the Inspector General.

In some embodiments, the retrieved custom list of excluded providers 154 may be generated by the list engine 153 from the published official list of excluded providers 107. The custom list of excluded providers 154 may include an entry for each provider that is added to the published official list of excluded providers 107 along with the date that each provider was added. For providers that were removed from the published official list of excluded providers 107, the list 154 may also include the date that each provider was removed.

At 230, whether a provider associated with the received claim is on the retrieved list is determined. The determination may be made by the compliance engine 155 searching the list of excluded providers 154 for each provider associated with the received claim 105. The compliance engine 155 may search using an NPI associated with each provider. If no provider is on the list 154, then the claim 105 complies with the official list of excluded providers 107 as of the service date of the claim 105. Accordingly, the claim 105 may be processed by the clearinghouse 103 and submitted to one or more government payors 170 on behalf of the organization 110 at 240. Else, the method 200 may continue to 250.

At 250, whether the service date associated with the claim is within a date range is determined. The determination may be made by the compliance engine 155. The date range may be associated with the provider in the custom list of excluded providers 154. The date range may be defined by the date that the provider was first added to the official list of excluded providers 107, and the date when the provider was removed from the list 107 (if ever). If there is no removal date for the provider, the compliance engine 155 may use the current date as the end of the date range.

If the service date of the claim 105 is not within the date range, then the claim 105 is in compliance with the official list of excluded providers 107 as of the service date of the claim 105. Accordingly, the claim 105 may be processed by the clearinghouse 103 and submitted to one or more government payors 170 on behalf of the organization 110 at 260. Else, the method 200 may continue to 270.

At 270, the claim is rejected. The claim 105 may be rejected by the clearinghouse 103. Depending on the embodiment, the notification engine 157 may generate and send a notification 159 that the claim 105 is rejected due to non-compliance with the official list of excluded providers 107. The notification 159 may identify the provider(s) whose presence on the list 107 at the time of the service date of the claim 105 caused the non-compliance. In the event that the claim 105 is later resubmitted by the organization 110, the claim 105 may be sent to the payor regardless of its status on the list of excluded providers 107. That a claim 105 was resubmitted may be detected by maintaining a list of rejected claims 105, or by using duplicate claim 105 detection functionality associated with the clearinghouse 103.

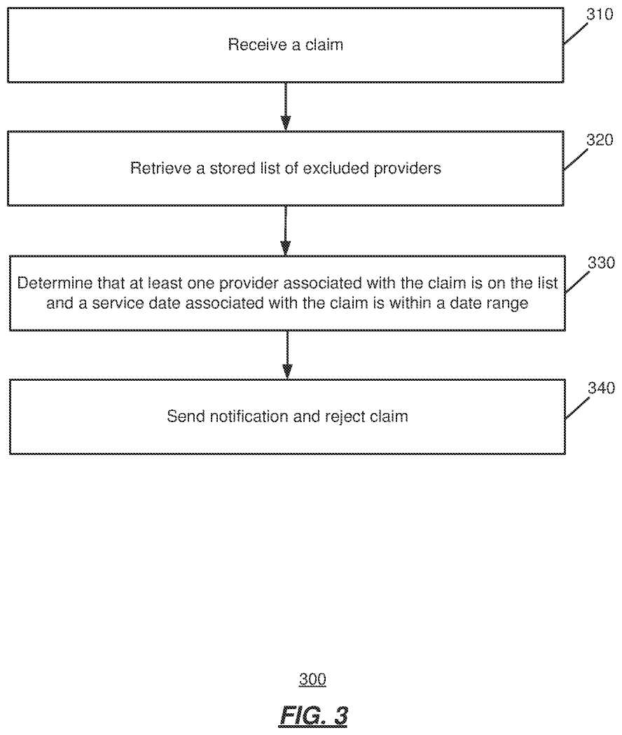

FIG. 3 is an illustration of an example method for determining if a claim is compliant with an official list of excluded providers. The method 300 may be implemented by the monitoring system 150.

At 310, a claim is received. The claim 105 may be received by the clearinghouse 103 from an organization 110 such as a hospital or medical office. The claim 105 may be a medical claim 105 and may be associated with a government payor 170 such as Medicare or Medicaid. The claim 105 may further include a service date that indicates the date or dates that the medical services were provided. The claim 105 may further identify one or more providers.

At 320, a stored list of excluded providers is retrieved. The stored list may be retrieved by the compliance engine 155. The stored list may be the custom list of excluded providers 154 that is based on an official list of excluded providers 107. The official list 107 may be published by a government entity or government payor 170.

At 330, that at least one provider associated with the claim is on the list and a service date associated with the claim is within a date range is determined. The determination may be made by the compliance engine 155 using the custom list of excluded providers 154. In some embodiments, the compliance engine 155 may first determine all providers associated with the claim 105 that are on the list of excluded providers 154. Then, for each determined provider, the compliance engine 155 may determine if the service date associated with the claim 105 falls within the date range associated with the provider in the list 154.

At 340, the claim is rejected. The claim 105 may be rejected by the clearinghouse 103. Depending on the embodiment, the notification engine 157 may generate and send a notification 159 that the claim 105 is rejected due to non-compliance with the official list of excluded providers 107. The notification 159 may identify the provider(s) whose presence on the list 107 at the time of the service date of the claim 105 caused the non-compliance.

FIG. 4 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an exemplary system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communication connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
receiving a claim from an organization by a computing device associated with a claim clearinghouse, wherein the claim is associated with a date and at least one provider;
retrieving a stored list of excluded providers by the computing device, wherein the list of excluded providers comprises an entry for each excluded provider of a plurality of excluded providers and a date range that includes a first date when the excluded provider was added to the Office of Inspector General list of excluded individuals/entities and a second date when the excluded provider was removed from the Office of Inspector General list of excluded individuals/entities;
determining whether the at least one provider is on the list of excluded providers by the computing device;
if it is determined that the at least one provider is on the list of excluded providers, determining whether the date associated with the claim is within the date range associated with the entry for the at least one provider on the list of excluded providers by the computing device; and
if it is determined the date associated with the claim is within the date range associated with the entry for the at least one provider on the list of excluded providers, rejecting the received claim by the computing device.

2. The method of claim 1, wherein rejecting the received claim comprises sending a notification to the organization with an indication that the at least one provider is an excluded provider.

3. The method of claim 1, further comprising:
receiving a published list of excluded providers; and
updating the stored list of excluded providers based on the published list of excluded providers.

4. (canceled)

5. The method of claim 1, wherein the at least one provider is a medical provider.

6. The method of claim 1, wherein the at least one provider is one or more of a referring provider, a rendering provider, or a billing provider.

7. The method of claim 1, wherein the claim is associated with a plurality of providers.

8. The method of claim 1, wherein the claim is a health insurance claim.

9. The method of claim 1, further comprising:
if it is determined the date associated with the claim is not within the date range associated with the entry for the at least one provider on the list of excluded providers, submitting the received claim to a government healthcare payor.

10. The method of claim 1, further comprising:
if it is determined that the at least one provider is not on the list of excluded providers, submitting the received claim to a government healthcare payor.

11. A method comprising:
receiving a claim from an organization by a computing device associated with a claim clearinghouse, wherein the claim is associated with a date and a plurality of providers;
retrieving a stored list of excluded providers by the computing device, wherein the list of excluded providers comprises an entry for each excluded provider of a plurality of excluded providers and a date range that includes a first date when the excluded provider was added to the Office of Inspector General list of excluded individuals/entities and a second date when the excluded provider was removed from the Office of Inspector General list of excluded individuals/entities;
determining that at least one provider of the plurality of providers associated with the claim is associated with an entry in the list of excluded providers with a date range that includes the date associated with the claim by the computing device; and
in response to the determination, rejecting the received claim by the computing device.

12. The method of claim 11, wherein rejecting the received claim comprises sending a notification to the organization with an indication that the at least one provider is an excluded provider.

13. The method of claim 11, further comprising:
receiving a published list of excluded providers; and
updating the stored list of excluded providers based on the published list of excluded providers.

14. (canceled)

15. The method of claim 11, wherein the plurality of providers are medical providers.

16. The method of claim 11, wherein the plurality of providers includes one or more of a refereeing provider, a rendering provider, or a billing provider.

17. The method of claim 11, wherein the claim is a health insurance claim.

18. A computer readable medium storing computer-executable instructions that when executed by at least one computing device cause the at least one computing device to perform the method comprising:
receiving a claim from an organization by a claim clearinghouse, wherein the claim is associated with a date and at least one provider;
retrieving a stored list of excluded providers, wherein the list of excluded providers comprises an entry for each excluded provider of a plurality of excluded providers and a date range that includes a first date when the excluded provider was added to the Office of Inspector General list of excluded individuals/entities and a second date when the excluded provider was removed from the Office of Inspector General list of excluded individuals/entities;
determining whether the at least one provider is on the list of excluded providers;
if it is determined that the at least one provider is on the list of excluded providers, determining whether the date associated with the claim is within the date range associated with the entry for the at least one provider in the list of excluded providers; and
if it is determined the date associated with the claim is within the date range associated with the entry for the at least one provider in the list of excluded provider, rejecting the received claim.

19. The computer readable medium of claim 18, wherein rejecting the received claim comprises sending a notification to the organization with an indication that the at least one provider is an excluded provider.

20. The computer readable medium of claim 18, wherein the method further comprises:
receiving a published list of excluded providers; and
updating the stored list of excluded providers based on the published list of excluded providers.
